(19) United States
(12) Patent Application Publication
(10) Pub. No.: US 2010/0286993 A1
(43) Pub. Date: Nov. 11, 2010

(54) Method and system for comunication, advertisement, commerce, marketplace, customer relationship management, content management, internet accounting and verification of information pertaining to legal marijuana over a network

(76) Inventor: Gunnar Lovelace, Ojai, CA (US)

Correspondence Address: Kirk Hermann, 150 Cerro Vista Way, Anaheim, CA, 92807, US

(21) Appl. No.: 12/387,870

(22) Filed: May 9, 2009

(51) Int. Cl. G06Q 50/00; G06Q 30/00; G06Q 99/00

(52) U.S. Cl. 705/2; 705/14.58

(57) ABSTRACT

A method and system for transmitting information pertaining to marijuana over a network for communication, advertisement, commerce, marketplace, customer relationship, content management, accounting and/or verification.

### TECHNICAL FIELD

The present invention generally relates to transmitting information pertaining to legal marijuana over a network, more particularly, a method and system of communication, advertisement, commerce, marketplace, customer relationship management, accounting, content management and verification of information pertaining to legal marijuana over a network.

### BACKGROUND

Scientists are discovering ever more physical and psychological benefits to the use of cannibas known commonly as marijuana, including but not limited to the ability to kill cancer cells found in an individual's brain and the ability to provide pain relief. In response, individual states and counties have legalized the advertising, purchase, sale, possession and/or usage of marijuana in specified quantities and for specified purposes. In some instances, these governments are authorizing the purchase, sale, possession and/or usage of marijuana via permits. For example, California authorizes the purchase, sale, possession and usage of marijuana to individuals for limited medicinal purposes after an individual has applied for and received a permit commonly known as a medical marijuana permit. Since commercial transactions involving legal marijuana, which is marijuana advertising, purchasing, selling, possession and/or usage that has been decriminalized and in some cases legally authorized by a government (federal, state and/or local government), are restricted by government regulations, there is a need for up-to-date information on topics including but not limited to: (1) the laws pertaining to the advertisement, sale, purchase, possession and/or usage of legal marijuana in specific geographic areas; (2) verified information as to who is authorized to advertise, sell, purchase, possess and/or use legal marijuana and under which restrictions including the type and amount authorized by each individual's permit, the authenticity of the permit, and the expiration dates of the license possessed by the seller (who is often a doctor or clinic) and the purchaser, possessor and/or user; (3) verified information pertaining to the historical transactions involving legal marijuana of sellers, purchasers, possessors and or users such as transaction dates, quantities and for purchasers, possessors and/or users their medical history. Digital networks, including the Internet and mobile telephony, are rapidly transforming the way information is being disseminated in public augmenting traditional forms of communication such as mail, overnight express mail, landline telephone and facsimile. However, due to its regulated nature, the dissemination of information regarding legal marijuana needs to be limited to only those individuals legally authorized to receive it to prevent access by individuals including but not limited to: (1) unauthorized sellers, such as individuals who want to intercept information regarding legal marijuana activities to attempt to lure individuals into illegal activities; and (2) unauthorized purchasers such as individuals who are underage or who are in a geographic area where the government prohibits the advertising, sale, purchase, possession and/or usage of legal marijuana.

As can be seen, there is a need for providing up-to-date information pertaining to legal marijuana. In addition, there is a need for verifying government authorized purchasers, sellers, possessors and users of legal marijuana. In addition, there is a need for securely transferring information pertaining to legal marijuana to specific individuals.

### SUMMARY OF THE INVENTION

In one embodiment of the present invention, a method for verifying an individual's personal information over a network, including receiving an individual's personal information transmitted over a network; verifying the individual's personal information; determining whether or not the individual legally qualifies to purchase marijuana; and notifying the individual whether or not he or she legally qualifies to purchase marijuana.

In another embodiment of the present invention, a method of selectively providing information pertaining to marijuana over a network, including: determining an individual's geographic location; determining whether the individual's geographic location is in a geographic area that has a government prohibiting the advertising, selling, purchasing or possessing of marijuana; transmitting over a network to the individual information pertaining to marijuana if the individual's geographic location is in a geographic area that does not have a government prohibiting the advertising, selling, purchasing or possessing of marijuana.

In still another embodiment of the present invention, a system for communicating information pertaining to marijuana over a network, including: means for storing information pertaining to marijuana; means for determining whether an individual is in a geographic area that has government regulations against the possession of legal marijuana; and means for retrieving information from means for storing information pertaining to marijuana and transmitting information pertaining to marijuana over a network to an individual who is not in is in a geographic area that has government regulations against the possession of marijuana.

These and other features, aspects and advantages of the present invention will become better understood with reference to the following drawings, description and claims.

### BRIEF DESCRIPTION OF THE DRAWINGS

FIG. 1 is a simplified schematic view of geographic area containing individuals in which a method and/or system of the present invention may be used according to a specific embodiment of the present invention;

FIG. 2 is a simplified schematic of two types of devices, a personal computer and a wireless device, both of which have access to at least one network such as the Internet and/or a wireless network according to a specific embodiment of a method and/or system of the present invention;

FIG. 3 is a block diagram showing the internal functional architecture of a computer according to a specific embodiment of a method and/or system of the present invention;

FIG. 4 shows a topology of a network with computers and wireless devices connected to a network, which is an integrated Internet and wireless network according to a specific embodiment of a method and/or system of the present invention;

FIG. 5 shows a system and/or method for managing communication, advertising, commerce and verification of information pertaining to legal marijuana over a network;

FIG. 6 is a flow chart of a method for verifying an individual's personal information over a network that determines whether or not the individual legally qualifies to purchase marijuana and notifies the individual whether or not he or she legally qualifies to purchase marijuana.

FIG. 7 is a flow chart of a method of selectively providing information pertaining to marijuana over a network that determines an individual's geographic location and transmits over a network to the individual information pertaining to marijuana if the individual's geographic location is in a geographic area that does not have a government prohibiting the advertising, selling, purchasing or possessing of marijuana.

FIG. 8 is a diagram of a user's screen showing a display connected to a network in which the display includes a graphical user interface containing hyperlinks to sites pertaining to legal marijuana including e-commerce, calendars, government laws, blogs and the like.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention generally provides transmitting information pertaining to legal marijuana over a network for communication, advertisement, commerce, customer relationship management, accounting, content management and/or verification.

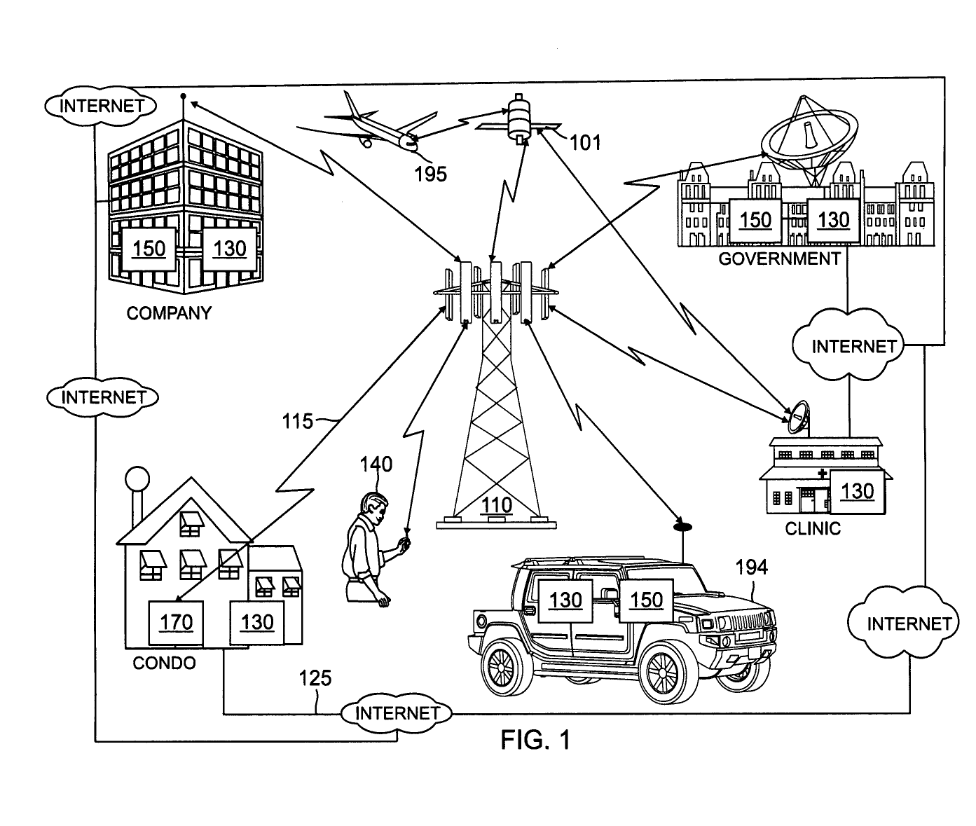

Referring now to the figures, FIG. 1 is a simplified schematic view of geographic area containing individuals in which a method and/or system of the present invention may be used according to a specific embodiment of the present invention. FIG. 1 includes a wireless network 115 (including both a satellite 101 and a wireless tower 110), the Internet 125, computers 130, a wireless device 140, databases 150, an radio frequency identification (RFID) tag 170 and vehicles 194 and 195 for executing a method and/or system according to one embodiment of the present invention.

In one embodiment of the present invention, wireless network 115 only includes a satellite system 101 and not a wireless tower 110. In one embodiment of the present invention, wireless network only includes a wireless tower 110 and not a satellite system 101. Internet 125 includes but is not limited to intranets, local area networks and wide area networks. Computers 130 include but are not limited to personal computers, stand alone computers, tower computers, servers, desktop computers, laptop computers, notebook computers, personal digital assistants, work stations, main frames, minicomputers, supercomputers and wearable computers. Moreover, computer 130 can be a special purpose computer programmed to perform the disclosed algorithms. Wireless device 140 includes but is not limited to cell phones, personal digital assistants, wireless internet cards, wireless modems and smart cards. Databases 150 include but are not limited to relational databases, object databases and post-relational databases. According to one embodiment of the present invention, a computer 130 and a database 150 can be coupled together via a LAN, an Ethernet connection, a WAN, a powerline and can be placed in a location such as but not limited to a government facility, a private company facility, a clinic, a vehicle or the like. RFID tags such as 170 include but are not limited to active RFID and passive RFID tags. RFID tags such as 170 may be affixed and/or embedded within legal marijuana permits to provide information as to geolocation of the legal marijuana permits according to a specific embodiment of a method and/or system of the present invention. RFID tags such as 170 may be affixed and/or embedded within vehicles 194 and 195 to provide information as to their geolocation according to one embodiment of the present invention. Wireless devices allow government authorized sellers and buyers to maintain up-to-date and in some cases real time communication. Sellers include but are not limited to doctors, clinic workers, pharmacists, private citizens, members of government, members of for profit and non-profit organizations, all of which are capable of communicating and deliver legal marijuana permits and/or legal marijuana at a fixed store front or via a mobile storefront according to a specific embodiment of a method and/or system of the present invention. Sellers' schedules and availability to meet potential purchasers can be communicated via a network according to a specific embodiment of a method and/or system of the present invention. Purchasers' requests (for example, to purchase legal marijuana, to visit a doctor and/or to obtain a legal marijuana permit) can be cued in computer 230 until such requests can be processed according to a specific embodiment of a method and/or system of the present invention. According to one embodiment of the present invention, vehicles 194 and 195 can contain computers 130, databases 150 and/or legal marijuana permits each containing an RFID tag 170 to be used to distribute legal marijuana and/or legal marijuana permits by authorized individuals such as doctors or the like. Individuals using wireless devices (such as 140) can send and receive information according to one embodiment of the present invention.

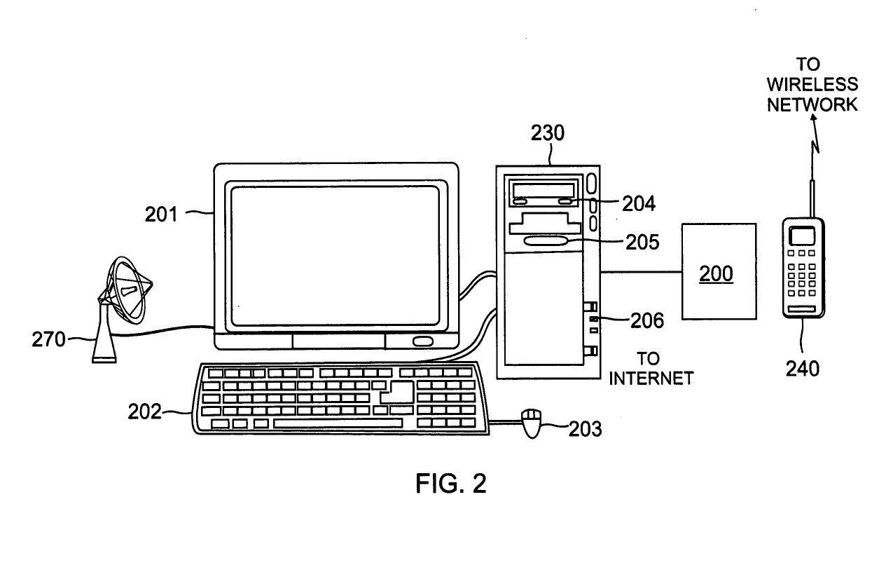

FIG. 2 includes a host computer 230, a monitor 201, a database 250 and a wireless device 240. Monitor 201 may be a CRT type, an LCD type, a touch sensitive screen, or any other type of color or monochrome display according to one aspect of the present invention. Also provided with computer 230 may be a keyboard 202 for entering text data and user commands, and a pointing device 203 (such as a mouse) for processing objects displayed on monitor 201 according to a specific embodiment of the present invention. Database 250 may be integrated within computer 230 according to a specific embodiment of the present invention.

Computer 230 may include a computer-readable memory medium such as a rotating disk 204 for storing readable data according to a specific embodiment of the present invention. Besides other programs, disk 204 can store application programs including web browsers by which computer 230 connects to a network, such as the Internet, and the systems described below, according to a specific embodiment of the present invention.

Computer 230 can also access a computer-readable floppy disk storing data files, application program files, and computer executable method steps embodying the present invention or the like via a floppy disk drive 205 according to a specific embodiment of the present invention. A CD-ROM interface (not shown) may also be provided with computer 230 to access application program files, audio files and data files stored on a CD-ROM according to a specific embodiment of the present invention. Computer 230 may access files and/or programs on other computers or on a database via the internet or a wireless network according to a specific embodiment of the present invention;

A modem, an integrated services digital network (ISDN) connection, a wireless connection, a satellite dish or the like may also provide computer 230 with a connection to the Internet according to a specific embodiment of the present invention. An Internet connection 206 may allow the computer 100 to download data files, audio files, application program files and computer-executable method steps according to a specific embodiment of the present invention. Computer 230 may include a wireless modem and/or connection to a satellite dish 270 for access to a wireless network according to a specific embodiment of the present invention.

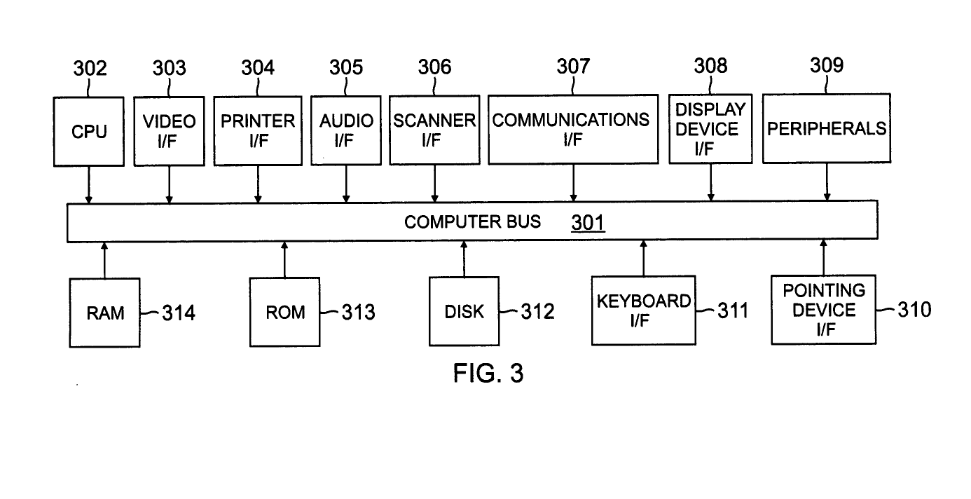

FIG. 3 is a block diagram showing the internal functional architecture of computer 230 according to a specific embodiment of the present invention. As shown in FIG. 3, computer 230 may include a CPU 302 for executing computer-executable method steps and interfaces with a computer bus 301. Also shown in FIG. 3 are a video interface 303, a printer interface 304, an audio interface 305, a scanner interface 306, a communication interface 307 (such as a web or wireless interface), a display device interface 308, a peripherals interface 309, a pointing device interface 310, a keyboard interface 311, a disk 312, read only memory (ROM) 313 and random access memory 314 according to specific embodiments of the present invention. Peripherals interface 309 provides connectivity to such things as a database, a scanner, a microphone, a video camera, a smart card terminal, a biometric scanner for receiving different types of biometric information from an individual, such as but not limited to finger print, retinal scan and hand writing sample, which can chosen at random. According to one embodiment of the present invention, sellers, purchasers, advertisers and/or possessors of legal marijuana input their personal information using a scanner, a microphone, a video camera, a smart card terminal, a biometric scanner. According to one embodiment of the present invention, sellers, purchasers, advertisers and/or possessors of legal marijuana are requested to input randomly chosen biometric information at a fixed location such as a clinic or via a moveable location such as using a doctor's vehicle, using a clinic worker's wireless device or via remote diagnostics of a patient by a doctor or clinic worker.

As described above, disk 204 may store operating system program files, application program files, web browsers, and other files according to a specific embodiment of the present invention. Some of these files may be stored on disk 204 using an installation program according to a specific embodiment of the present invention. For example, CPU 302 may execute computer-executable method steps of an installation program so that CPU 302 can properly execute the system and/or method according to a specific embodiment of the present invention.

A random access main memory (“RAM”) 314 may also interface to computer bus 301 to provide CPU 302 with access to memory storage according to a specific embodiment of the present invention. When executing stored computer-executable method steps from disk 204 (or other storage media such as floppy disk 205, shown in FIG. 2, or internet connection such as 206, shown in FIG. 2), CPU 302 stores and executes the method steps out of RAM 314 according to a specific embodiment of the present invention.

Read only memory (“ROM”) 313 may be provided to store invariant instruction sequences such as start-up instruction sequences or basic input/output operating system (BIOS) sequences for operation of keyboard 202 according to a specific embodiment of the present invention.

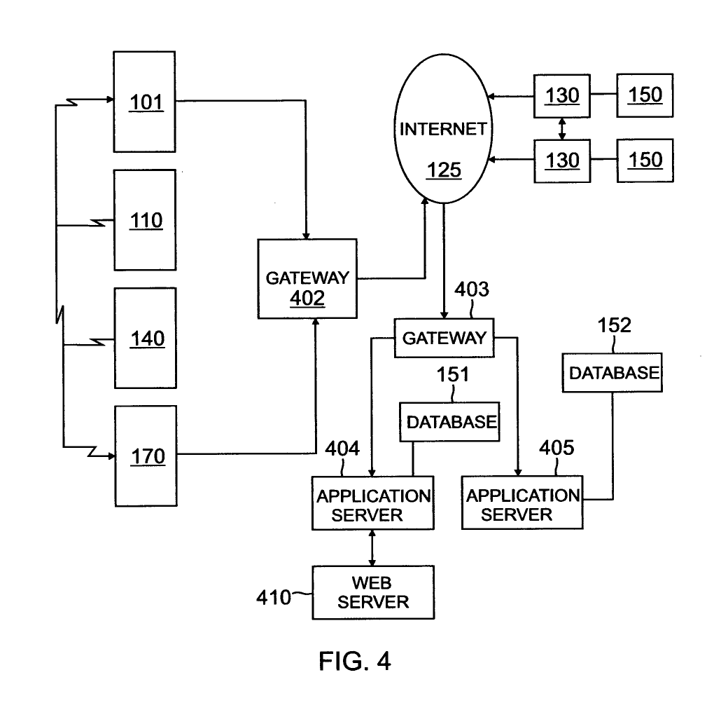

FIG. 4 shows a typical topology of an integrated wireless/Internet network according to a specific embodiment of the present invention. Network can include just a wireless network or just an internet network according to specific embodiments of the present invention. For illustration purposes, a satellite 101, a wireless tower 110, a wireless device 140 and a RFID tag 170 are shown connected to each other through a wireless network 115 and to the Internet 125 through a gateway 402 according to a specific embodiment of the present invention. Also shown in FIG. 4 are computers 130 connected to each other, to databases 150 and the Internet 125 via communication interface 207 (shown in FIG. 2) according to a specific embodiment of the present invention. Communication interface 207 may be a modem, network interface card, or a unit for providing connectivity to other computer systems over a network using protocols such as X.25, Ethernet, or TCP/IP, interactive voice response, or any device that allows, directly or indirectly, computer-to-computer communications.

It is noteworthy that the invention is not limited to a particular number of computers or wireless devices. Any number of computers or wireless devices that can be connected to a network, such as a wireless network 115 or the Internet 125, or any other network, may be used.

FIG. 4 further shows a second gateway 403 that may connect a network of application servers 404 and 405 to the Internet 125 according to a specific embodiment of the present invention. Application servers 404 and 405 may be connected with each other over a computer network according to a specific embodiment of the present invention. A web server 410 may be connected to an application server, such as application server 404 according to a specific embodiment of the present invention. Application servers 404 and 405 can provide content, including information about a product and/or service, to a user from database 151 and/or 152 according to a specific embodiment of the present invention. Application servers 404 and 405 can execute a method and/or system of the present invention according to a specific embodiment of the present invention.

The Internet connects thousands of computers world wide through well-known protocols, for example, Transmission Control Protocol (TCP)/Internet Protocol (IP), into a vast network. Information on the Internet is stored world wide as computer files, mostly written in the Hypertext Mark Up Language (“HTML”). Other mark up languages, e.g., Extensible Markup Language (“XML”) as published by W3C Consortium, Version 1, Second Edition, October 2000, ©W3C may also be used. The collection of all such publicly available computer files is known as the World Wide Web (“WWW”). The WWW is a multimedia-enabled hypertext system used for navigating the Internet and is made up of hundreds of thousands of web pages with images and text and video files, which can be displayed on a computer monitor. Each web page can have connections to other pages, which may be located on any computer connected to the Internet.

A typical Internet user uses a client program called a “Web Browser” to connect to the Internet. A user can connect to the Internet via a proprietary network, such as America Online, or via an Internet Service Provider, e.g., Roadrunner. The web browser may run on any computer connected to the Internet. Currently, various browsers are available of which two prominent browsers are Firefox and Microsoft Internet Explorer. The Web Browser receives and sends requests to a web server and acquires information from the WWW. A web server is a program that, upon receipt of a request, sends the requested data to the requesting user. A standard naming convention known, as Uniform Resource Locator (“URL”), has been adopted to represent hypermedia links and links to network services. Most files or services can be represented with a URL.

URLs enable Web Browsers to go directly to any file held on any WWW server. Information from the WWW is accessed using well-known protocols, including the Hypertext Transport Protocol (“HTTP”), the Wide Area Information Service (“WAIS”) and the File Transport Protocol (“FTP”), over TCP/IP protocol. The transfer format for standard WWW pages is Hypertext Transfer Protocol (HTTP).

Wireless network 115 includes any type of communication network that is wireless (information transmission system that uses electromagnetic waves, such as radio waves, as the carrier of information), and can include but is not limited to any telecommunications network whose interconnections between nodes is implemented without the use of wires. Wireless network can include but is not limited to: wireless personal area network (WPAN), Bluetooth, ZigBee, Wi-Fi, IEEE 802.11, microwave, WiMAX, IEEE 802.16d/802.16e, Global System for Mobile Communications (GSM), Personal Communication Service (PCS), D-AMPS, wireless LAN (WLAN), 1G, 2G, 2.5 G and 3G.

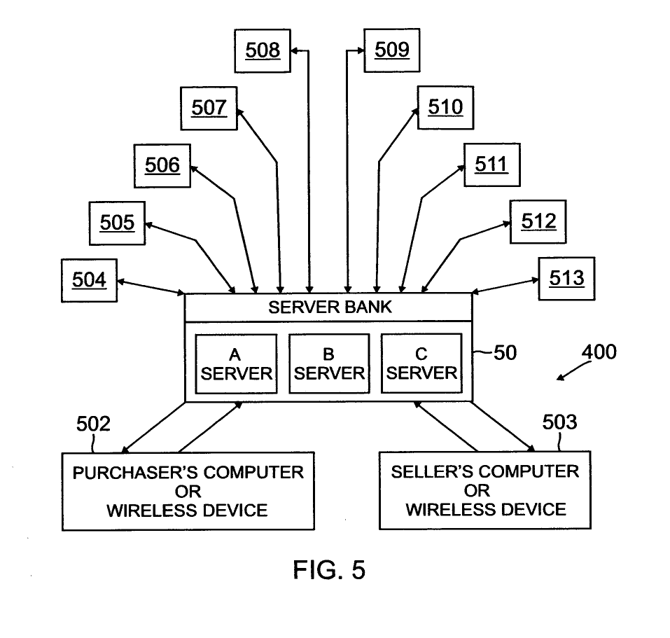

FIG. 5 shows a system 400 for executing a method and/or system according to one embodiment of the present invention. Server bank 501 may include multiple server computers (“servers”) for processing information requests between client computers and/or wireless devices such as 502 (such as purchasers' computers) and vendor management computers and/or wireless devices such as 403 (such as sellers' computers) according to a specific embodiment of the present invention. Although FIG. 4 shows an exemplary computer server bank 112 to include three servers A, B, and C, any number of servers may be used.

Continuing with FIG. 5, the server bank 501 may be attached to a communication link (such as the Internet or an intranet) with multiple seller locations 504-512. Although FIG. 5 shows an exemplary group of nine seller/purchaser locations 504-512, any number of seller/purchaser locations may be used.

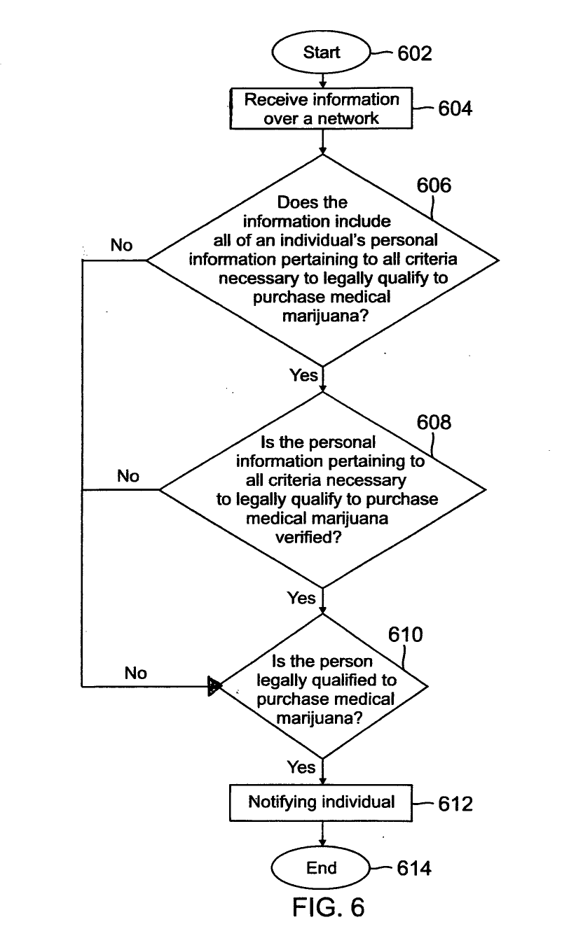

FIG. 6 shows a flow chart of an example of operation of one embodiment of a method for verifying an individual's personal information over a network. According to a specific embodiment of the claimed invention some, all or none of the steps of the method can involve human interaction. According to a specific embodiment of the claimed invention, some, all or none of the steps of the method can be automated. The method for verifying starts 602 when information transmitted over a network 604 is received. Information can be binary, symbols, text, photographs, holographs, biometric, audio, video, a combination thereof or the like. Moreover, information can be transmitted by a human (for example a purchaser of legal marijuana or a legal marijuana permit or a doctor) or be automated without the use of a human. According to this method at step 606 a determination is made to determine whether the information transmitted over a network includes all of an individual's personal information pertaining to all criteria (such as but not limited to age, reason for seeking permit, doctor's approval) necessary to legally qualify to purchase medical marijuana. According to one embodiment of the present invention this step 606 involves a determination whether the information transmitted over a network includes all of an individual's personal information pertaining to all criteria necessary to legally qualify to purchase marijuana. At step 608 a determination is made whether the information pertaining to all criteria necessary to legally qualify to purchase medical marijuana verified. At step 610 a determination is made whether the person legally qualifies to purchase medical marijuana. At step 612 a determination is made whether the person legally qualified to purchase medical marijuana, the individual is notified whether or not he or she is legally qualified to purchase medical marijuana at step 612 and the method ends at 614. If a determination cannot be made at any of these steps 606, 608 and/or 610, then the individual is notified whether or not he or she is legally qualified to purchase medical marijuana at step 612 and the method ends at 614. According to one embodiment of the present invention medical marijuana refers to legal medical marijuana. According to one embodiment of the present invention legally qualify means there are no federal, state and/or city laws against purchasing legal marijuana. According to one embodiment of the present invention legally qualify means there are no federal, state and/or city laws against purchasing legal medical marijuana. According to one embodiment of the present invention the terms “individual” and “person” refer to the same single human being.

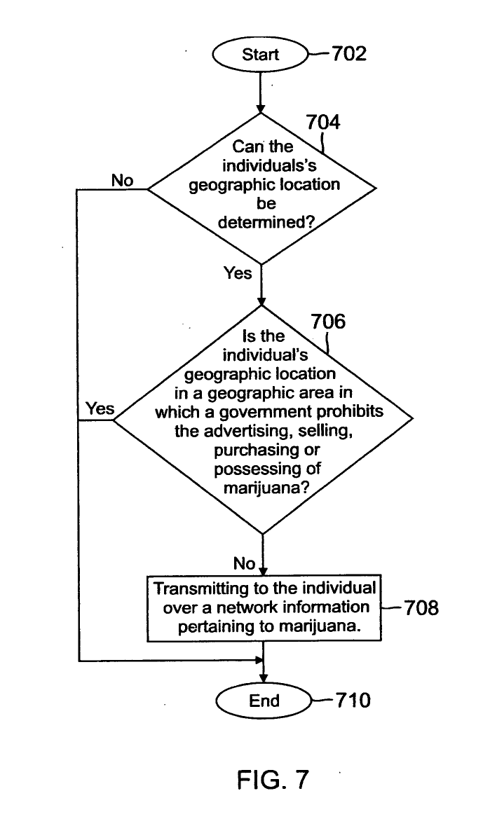

FIG. 7 shows a flow chart of an example of operation of one embodiment of a method for selectively providing information pertaining to marijuana over a network that determines an individual's geographic location and transmits over a network to the individual information pertaining to marijuana if the individual's geographic location is in a geographic area that does not have a government prohibiting the advertising, selling, purchasing or possessing of marijuana. According to a specific embodiment of the claimed invention some, all or none of the steps of the method can involve human interaction. According to a specific embodiment of the claimed invention, some, all or none of the steps of the method can be automated. The method for verifying starts 702 when a determination is made whether an individual's geographic location can be determined. According to a specific embodiment of the claimed invention step 702 includes pinging a computer, geo sniffing and/or ip tracking. According to a specific embodiment of the claimed invention geographic location can include computer registered to an individual and/or physical location of the computer within a country, state and/or city. If the individual's geographic location cannot be determined (704) then the method ends at 710. If the individual's geographic location can be determined then the method determines at step 706 whether the individual's geographic location is in a geographic area in which a government (federal, state, and or local) prohibits the advertising, selling, purchasing or possessing of marijuana. If the result of determination at step 706 is “yes” (i.e., the individual's geographic location is in a geographic area in which a government (federal, state, and or local) prohibits the advertising, selling, purchasing or possessing of marijuana) then the method ends at 710. If the result of the determination at step 706 is “no” (the individual's geographic location is not in a geographic area in which a government (federal, state, and or local) prohibits the advertising, selling, purchasing or possessing of marijuana) then the method advances to step 708 which includes transmitting to the individual over a network information pertaining to marijuana. Information can be binary, symbols, text, photographs, holographs, biometric, audio, video, a combination thereof or the like. Moreover, information can be transmitted by a human (for example a purchaser of legal marijuana or a legal marijuana permit or a doctor) or be automated without the use of a human. According to one embodiment of the claimed invention information pertaining to marijuana is information pertaining to legal marijuana. According to one embodiment of the claimed invention information pertaining to marijuana is information pertaining to legal medical marijuana. According to one embodiment of the present invention the terms “individual” and “person” refer to the same single human being.

According to a specific embodiment of the present invention, a method and/or system includes verification of information pertaining to legal marijuana over a network. According to a specific embodiment of the present invention, users (including but not limited to advertisers, sellers, purchasers and/or possessors of legal marijuana) can submit their personal information (for example, their information pertaining to their medical marijuana permit) over a network for the purposes of validating their legal right in their geographic area to advertise, sell, purchase and/or possess legal marijuana (for example, medical marijuana).

According to a specific embodiment of the present invention, a method and/or system includes verification of information pertaining to legal marijuana over a network includes automatic verification of a user's personal information (for example, medical marijuana permit information or government issued medical marijuana card) against a government or 3^{rd} party's database or databases to validate the right to advertise, sell, purchase and/or possess legal marijuana (for example, medical marijuana). According to a specific embodiment of the present invention, a method and/or system includes verification of information pertaining to legal marijuana over a network includes verification of a user's personal information (for example, medical marijuana permit information) by a human accessing a government or 3^{rd} party's database or databases to validate the right to advertise, sell, purchase and/or possess legal marijuana (for example, medical marijuana).

According to a specific embodiment of the present invention, a method and/or system enables a user to apply for a government permit giving the individual the right to advertise, sell, purchase and/or possess legal marijuana (for example, medical marijuana) via an automated or semi automated process that asks the user a series of questions over a network in which information received is stored in a database, the questions eliciting such information as the user's personal information, medical ailments, medical records, prior usage of marijuana, driver's license, age, location of domicile (city, state and/or country) and government identification, According to a specific embodiment of the present invention if the user does not qualify based on for example a mismatched identification or medical conditions that do not qualify for a permit, then the user's application process is rejected. According to a specific embodiment of the present invention the review of a user's application, medical status, ailments or process over a network for securing a medical doctor approved recommendation letter (or medical marijuana permit). According to a specific embodiment of the present invention the user submits their information online, and if a medical doctor is not available then the user's application is queued in a pool while a group of medical doctors is notified of the need to review the application. According to a specific embodiment of the present invention the doctor may review, approve or reject the users right to secure a recommendation letter or permit for medical marijuana live with the user real over a network or may review the users information fed to the doctor from a queue pool, after the user has applied. According to a specific embodiment of the present invention the queue pool may connect the doctor to the user over the network, VOIP, IVR, phone, video-chat so the legal requirements for a live medical analysis is fulfilled as part of producing a recommendation letter, government documents or permit for medical marijuana for the user. According to a specific embodiment of the present invention a medical doctor may review, approve or reject a user's application over a network (for example via a graphical user interface on a webpage or on a wireless device).

According to a specific embodiment of the present invention, a medical doctor may review a person's application to purchase and/or possess legal marijuana (for example medical marijuana) via a live audio and/or video stream such as but not limited to instant messaging using a webcam, videoconferencing, phone call, phone call with a picture of a user and/or voice recognition. According to a specific embodiment of the present invention if the user qualifies to purchase and/or possess legal marijuana, then this authorization and/or the user's legal medical marijuana permit number is transmitted over a network to private or government offices (federal, state, county and city) and stored in a database and/or sent to the user to print out. According to a specific embodiment of the present invention a medical doctor may be required to personally sign the users application, medical records, government documents, recommendation letter or permit for medical marijuana. According to a specific embodiment of the present invention a doctor may sign the documents through a network producing a digital signature, uploading an image of their signature, typing their name as a digital signature, signing their name via the mouse, keyboard or joystick, signing their name with their finger or digital pen via a computer or mobile device. According to a specific embodiment of the present invention doctors' signature will be stored in the database and attached to the users documents. According to a specific embodiment of the present invention the doctor users, site administrator/s, According to a specific embodiment of the present invention audit agents, sellers, shipping agents, buyer or subsequent doctor/s may all access over a network to view the signature and users documents (as required by law and allowed based upon privacy requirements).

According to a specific embodiment of the present invention, a legal marijuana permit expiration notification (PEN) module which enables legal medical marijuana permit holders to be notified via internet, mobile or interactive voice response when their permit, letter of recommendation, or government issued medical marijuana card is nearing expiration. According to a specific embodiment of the present invention, the legal medical marijuana permit holder grants the PEN system the ability to contact the user prior to the expiration date of his or her legal marijuana permit, letter of recommendation, or government issued medical marijuana card (also known as a legal marijuana permit) to assist the user in renewing prior to expiration.

According to a specific embodiment of the present invention, a method and/or system, a user's geographic location is detected using computer software and/or hardware that can intercept and log traffic passing over a digital network or part of a network and can decode each packet it captures and analyzes its content according to the appropriate specification (for example the request for comments (RFC)), examples of which include but are not limited to a packet analyzer, a network analyzer, a protocol analyzer, a sniffer (for example, an Ethernet sniffer or a wireless sniffer) or geo tracker. According to a specific embodiment of the present invention, a method and/or system, a user's geographic location is detected and if the user is located in a geographic area (state or city) having laws against the advertising, selling, purchasing and/or possession of legal marijuana, then the user's access to specific or all content available over the network is blocked. According to a specific embodiment of the present invention, a method and/or system, a user's geographic location is detected and if the user is located in a geographic area (for example, a city and/or a state) having laws against the advertising, selling, purchasing and/or possession of legal marijuana, then the user's access to content available over the network that originates from a computer (such as a server) or a wireless device from within this same geographic area is blocked and/or the user's access is redirected to content available over the network that that originates from a computer (such as a server) or a wireless device from within a geographic area (for example, a city, state, and/or nation) that does not have laws against the advertising, selling, purchasing and/or possession of legal marijuana.

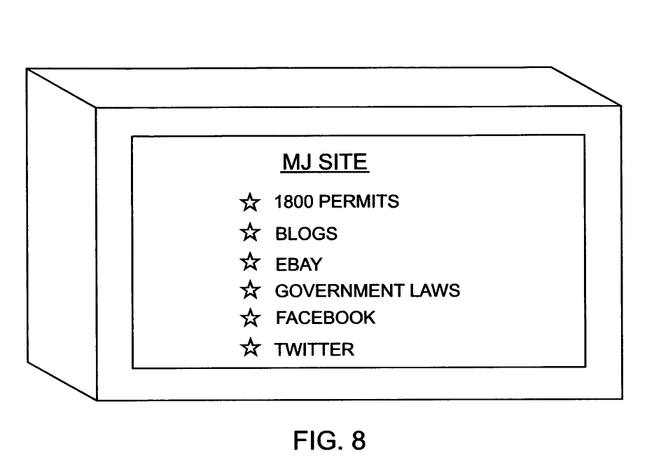

FIG. 8 is a diagram of a potential purchaser's screen showing advertisement of information pertaining to legal marijuana over a network, wherein the screen contains links to e-commerce sites, calendars, advertising and blogs all of which pertain to legal marijuana. According to a specific embodiment of the present invention, a method and/or system includes databases that provide content management that is available to a user over a network.

According to a specific embodiment of the present invention, a method and/or system provides for advertising, selling and purchasing of legal marijuana (for example medical marijuana) over a network that has the capability of notifying users of their completed e-commerce transaction via e-mail or wireless device. According to a specific embodiment of the present invention, a method and/or system provides for a handshake or data link between an e-commerce system, a payment gateway and a credit card processor for the purposes of completing transactions involving legal marijuana (for example medical marijuana) over a network. According to a specific embodiment of the present invention, a method and/or system provides for payment of legal marijuana (for example medical marijuana) over a network through the use of credit or debit cards or third party payment systems such as Paypal, Google, Amazon or wire transfer.

According to a specific embodiment of the present invention, a method and/or system tracks users visiting websites containing information pertaining to legal marijuana (clicks) as well as users visiting other sites via hyperlinks (click throughs) to economically compensate sites for generating traffic. According to a specific embodiment of the present invention, a method and/or system provides for modification of the inventory of legal marijuana to be purchased over a network via an administrator.

According to a specific embodiment of the present invention, a method and/or system tracks users purchases over a network and is capable of blocking access to sites on a network when the user has violated government laws pertaining to marijuana (for example medical marijuana laws).

According to a specific embodiment of the present invention, a method and/or system each legal medical marijuana permit can be tracked by an RFID device attached to or embedded within the permit.

According to a specific embodiment of the present invention, a method and/or system provides a marketplace for legal medical marijuana accessible over a network in which users are able to search for legal marijuana by criteria such as type, price, location and rating. According to a specific embodiment of the present invention, a method and/or system provides for delivery of legal marijuana (for example, medical marijuana) for example by a medical doctor or government worker and/or using an armored automobile.

According to a specific embodiment of the present invention, a method and/or system enables a user to be able to enter into fields on their computer or wireless device their personal information including but not limited to their driver's license, legal medical marijuana permit number and medical history). According to a specific embodiment of the present invention, a method and/or system encrypts information that is transmitted over a network.

According to a specific embodiment of the present invention, a method and/or system includes optical character recognition (OCR) to allow for scanning of information such as documents (for example, an individual's medical history files) relating to verifying and establishing a user's legal right to advertise, sell, purchase and/or possess legal marijuana (for example, medical marijuana), which are uploaded and/or sent over a network and possibly stored.

According to a specific embodiment of the present invention, a method and/or system includes a legal marijuana e-commerce widget that enables a legal marijuana supplier or seller to load their legal marijuana products into a database and into an e-commerce engine which can be easily distributed across the internet. According to a specific embodiment of the present invention, once the legal marijuana supplier or seller has entered their products, the e-commerce widget dynamically produces HTML code, Java or a flash widget, that they can pasted around the network (Internet or wireless web), embed on other webpages or embed via an iframe, which enables the legal marijuana supplier to upload products into an e-commerce system through one internet database interface, which can then be accessed by numerous distributed media platforms at the same time (such as websites, mobile and social networks).

According to a specific embodiment of the present invention, a method and/or system enables Affiliates to embed or promote the e-commerce widget or marketplace, and to earn a commission on the sales that they produce for the legal marijuana supplier or seller. According to a specific embodiment of the present invention, an affiliate signs up for an account, and enters their bank account information or paypal, google or amazon account information with the e-commerce widget dynamically tracking and distributing the commissions to the affiliate. According to a specific embodiment of the present invention, the e-commerce widget and marketplace have a system where the legal marijuana supplier or seller can manage their account by tracking information including sales, visitors, affiliates, affiliate sales, affiliate locations where the legal marijuana e-commerce widget or marketplace is being accessed and the source of traffic. According to a specific embodiment of the present invention, the affiliate account will be able to track visitors, commissions, click through rates, traffic sources and payment history through legal marijuana e-commerce widget and marketplace. According to a specific embodiment of the present invention sellers are able to customize the look and feel of the e-commerce widget and their marketplace store through an internet based designer interface by uploading HTML code and graphics, or selecting from templates provided by site administrators or other users enabling the sellers to create a shopping environment that matches the look and feel of their website, graphics and logo.

According to a specific embodiment of the present invention, a method and/or system enables an automated process verifying the non-profit status of legal marijuana suppliers and/or sellers that want to utilize the shopping cart and e-commerce and/or legal marijuana e-commerce widget. According to a specific embodiment of the present invention, legal marijuana suppliers or sellers will enter the legal name of the nonprofit entity, the EIN number and can upload the any other government documents demonstrating non profit status. According to a specific embodiment of the present invention, the system will use an automated internet based process to verify the validity of non-profit status against government and/or third party databases. According to a specific embodiment of the present invention, in some cases the validity of the nonprofit status will have to be approved by a human reviewing their application. According to a specific embodiment of the present invention once approved, a suppler and/or seller of legal marijuana will be able to sell their marijuana in the ecommerce marketplace or through the marijuana e-commerce widget.

According to a specific embodiment of the present invention, a method and/or system will notify an approved individual via the internet that a new supplier or seller seeks to utilize the shopping cart and e-commerce and/or legal marijuana e-commerce widget. According to a specific embodiment of the present invention, the approved individual will review their documents and designate their qualification and upon approval the legal marijuana supplier or seller will be notified over a network via the internet or interactive voice response system, and the database will load the suppliers' or sellers' products into the marketplace so that users may purchase products supplied by the legal medical marijuana supplier or seller.

According to a specific embodiment of the present invention, a method and/or system provides an insurance connection layer that is capable of allowing users to enter their insurance information over a network. According to a specific embodiment of the present invention a user will enter via the internet or a wireless device his or her insurance provider's name, phone number, the insurance card holder's name, the insurance card holder's phone number, the insurance member's ID number and/or cardholders date of birth and this information will be held in a database available to the user and system administrators for future reference. The validity of the information supplied by the user will be verified manually or through an automated system over the internet. According to a specific embodiment of the present invention, system will have a marijuana customer relationship management software (MCRM) for purchasers who are buying legal marijuana, who can join a legal marijuana sellers' organization via the internet. According to a specific embodiment of the present invention, using this system a user will select the desired buyer from the legal marijuana marketplace, and join their specific group via the internet or a wireless device and the system may notify the legal marijuana seller via the internet that a new user has joined their organization.

According to a specific embodiment of the present invention, the system will track in a database total users who are members of the legal marijuana sellers' organization. According to a specific embodiment of the present invention, legal marijuana sellers are able to manage the users who have joined their organization and in some cases, the system may (depending on local law requirements) prevent the user from buying legal marijuana from a legal marijuana seller, before first joining the seller's organization. According to a specific embodiment of the present invention, the system will enable the legal marijuana seller to control via a connection to a network (such as the internet or wireless network) whether a user can automatically join their organization and start buying legal medical marijuana immediately, or whether the user must first be approved by the legal marijuana seller before they can start buying. According to a specific embodiment of the present invention in some instances and regions sellers will be required to upload into a database via the internet which is tied to their account, the organizational documents, bylaws, proxy voting agreements related to the formation and management of their specific seller organization.

According to a specific embodiment of the present invention, a method and/or system, buyers may not be able to join the seller;s organization, without first being presented with the seller's organizational documents and agreeing to them, whereby the seller's organizational documents will be displayed over the network from the database, and presented to the buyer to read and agree to as part of the internet based process for the buyer to join the seller;s organization. According to a specific embodiment of the present invention, the MCRM is capable of tracking the number of seller organizations to which a specific buyer belongs, and is capable of restricting the ability for the buyer to be part of more than one seller at the same time (for example, to protect the buyer and/or seller based upon local laws and/or regulations).

According to a specific embodiment of the present invention, a method and/or system enables based upon the location of the seller the MCRM will track how many plants can be grown as a direct relationship to the buyers who have joined the organization, therefore when a buyer leaves the organization, the seller may be notified, and the display of the numeric value of the total plants that can be grown, will reflect the new totals of their real time total membership. According to a specific embodiment of the present invention, the MCRM can be accessed by sellers by downloading an application over a network and/or through a browser window. According to a specific embodiment of the present invention, the MCRM system will enable sellers to enter the information including all the buyers (or members of their organization) and have data fields stored in the database for buyer's name, address, doctors recommendation number, government issued legal marijuana ID card (for example, medical marijuana ID program number), phone number, e-mail address, payment info, disease type, notes section, image of legal marijuana permit, image of driver license, photo of buyer, image of county, state or national legal marijuana ID card, image of recommendation letter from doctor, how buyer was referred field, action item field, credit card number field, credit card expiration number, credit card security code number, payment history view, drivers license number, age, gender, notes fields and notes with scheduling tools.

According to a specific embodiment of the present invention, a method and/or system enables that from the MCRM the seller can view any specific buyer's account who is a member of their organization and charge them for a recent order and in turn will send the order to the legal marijuana shipping module (MSM) system over a network. According to a specific embodiment of the present invention, from the MCRM, the buyer and seller can send and receive messages over the internet to each other. According to a specific embodiment of the present invention, the MCRM can enable the seller to create and manage varying types of sub administration accounts whereby the seller can create accounts for staff members who need to be able to interact with and provide customer services to the buyers of the organization. According to a specific embodiment of the present invention the MCRM may be linked to a seller's shipping provider over a network (such as a courier, UPS, Fedex, USPS) and is capable of enabling the MCRM administrator/s to view, track, link to shippers website, link to tracking specific package, dynamically pull tracking number for package/s shipped to users. Administrator/s or buyers may opt to be notified via a network, when a package has been shipped, what the tracking number is for the package, when its is due to arrive and who the shipping provider is (with their contact information provided). According to a specific embodiment of the present invention a buyer and/or user can log into their account via a network or click on a link sent via email or mobile, which enables the buyer and/or user to see the status of their account, their order history, the status of any pending packages, tracking number for the packages, link to shipping providers website to track specific package, who is shipping specific packages and/or how to contact the shipping provider. According to a specific embodiment of the present invention the MCRM will send over a network to the seller's administrator or shipping agent the buyer's information, seller's information and any other documents (including but not limited to seller's non profit status, seller's membership agreement, buyer's government issued ID, buyer's recommendation letter, buyer's permit, buyer's government issued marijuana ID card), which may need to be attached to package (during part of or entire shipping process from seller to buyer) or filed for record by an administrator, or shipping agent (as required by county, state or national laws for transporting of legal marijuana). According to a specific embodiment of the present invention, within the MCRM system is a conflict resolution center, whereby buyers and sellers can resolve problems with a buyer's experience purchasing legal marijuana from a seller. According to a specific embodiment of the present invention if a resolution can not be resolved, then the MCRM master administrator will be notified and the conflict status will remain persistently attached (i.e., until resolved) to the seller's account and will be viewable by all buyers in their organization and by all prospective buyers in the marketplace. According to a specific embodiment of the present invention the MCRM will has have a built in scheduling tool which enables the seller to identify a reminder that will appear in their daily items view, which reminds them on specific dates and times to ship, bill or call specific buyers, vendors, shipping agents, or MCRM administrators, seller staff, contractors, etc.

According to a specific embodiment of the present invention, a method and/or system enables the ability to dynamically display federal, state and county level laws pertaining to marijuana and these laws may be accessed through the network connecting to a 3^{rd} party or government database.

According to a specific embodiment of the present invention, a method and/or system when an order to buy legal marijuana is sent to the Marijuana Shipping Module (MSM), the database will produce a printable package from the database that includes the image of the recommendation letter of the buyer, an image of the buyer's driver license number, articles of organization of the seller's organization, image of the buyer's county, state or national “marijuana ID program” card, address of the buyer, and a copy of the legal statues that clearly identify the ability to transfer or ship legal marijuana with the proper paperwork. According to a specific embodiment of the present invention, the MSM will have a system for dynamically determining which shipping agent to use depending on where the buyer is located or what type of shipping the buyer wishes to use. According to a specific embodiment of the present invention, the MSM will send the buyer's order via the internet, SMS or IVR to the shipping agent and notify shipping agent of need to pickup a package at a specific location or time. According to a specific embodiment of the present invention, the seller will be able to print the package and attach it to the legal marijuana that is being shipped to the buyer and then give the final package to the shipping agent so that the legal marijuana can be shipped with all required documentation.

According to a specific embodiment of the present invention, a method and/or system has a Master Marijuana Administrator Platform (MMAP) which is accessible through a network and enables control, access, viewing, deleting, altering, flagging, creating and/or managing of all areas of the e-commerce marketplace, accounting, MCRM, CMS, blogs, forums, ratings, reviews, profiles, accounts, advertising, social networking and verification processes for users, buyers, shipping agents, doctors, and sellers. According to a specific embodiment of the present invention the MMAP has a master administrator which can create sub administrator accounts with specific management rights (including buy not limited to creation and/or deletion of data) and access rights to specific parts of the MMAP. According to a specific embodiment of the present invention using the MMAP, an administrator is able to control and serve the needs of the respective marijuana constituents. According to a specific embodiment of the present invention the MMAP serves as a network based dashboard of all system functions, enabling the administrator to move into any specific module (e-commerce, accounting, MCRM, CMS, blogs, forums, social networkings, etc) and from the module manage and engage the entire application, database or specific area of functionality that the administrator is focused on. According to a specific embodiment of the present invention administrators are capable of creating and maintaining a legal database of all county, state and government laws which pertain to the advertising, viewing, selling, buying and/or possessing of legal marijuana. According to a specific embodiment of the present invention each law and region entered can be toggled to attach behavior classes which may modify administrators, sellers, buyers, users, affiliates, shipping providers usage through all areas of the MMAP (ecommerce, CMS, accounting, MCRM, etc). According to a specific embodiment of the present invention a local law entered into the Legal database may have a behavior class for requiring a seller in a specific region to have certain documents (such as a government permit) before they can start selling through the e-commerce system, or may require a buyer in a specific regions to have certain requirements met before they can start buying legal marijuana. According to a specific embodiment of the present invention using the MMAP, an administrators is able to create, manage and track audit accounts specific to created 3^{rd} party entites, government entities, and/or law enforcement entity accounts. According to a specific embodiment of the present invention some audit accounts may have global viewing rights to entire MMAP (and its sub modules) enabling network based viewing and auditing of entire database of sellers, buyers, affiliates or shipping agents (and all their data in various modules such as ecommerce, accounting, MCRM, etc.) while other Audit accounts may be restricted by MMAP administrator(s) to enable access to all data related to buyers, sellers, shipping agents, affiliates located in the region (city, county, state, national) to which their direct influence, oversight or enforcement applies. According to a specific embodiment of the present invention using the MMAP, administrators are able to manage and track all Audit account activity and produce reports for all or specifically selected Audit accounts. According to a specific embodiment of the present invention an Audit account may flag through their account, that more information is required or missing for all or specific buyers, sellers, shipping agents and/or affiliates. According to a specific embodiment of the present invention audit accounts can designate different classes of flags or notes which accompany a flag, which relay a variety of specific issues (such as but not limited to buyers recommendation letter or government issued marijuana ID being expired, sellers missing organizational documents, etc). According to a specific embodiment of the present invention when an audit account is flagged, the MMAP administrator(s) are notified as are the related buyers, sellers, shipping agents and/or affiliates who are connected to the flagged action designated by the Audit account. According to a specific embodiment of the present invention the MMAP administrators may select that all or specific buyers, sellers, shipping Agents and/or affiliates are notified via their internet accounts, email, mobile, phone call, IVR when an audit account has looked into data related to them or flagged them in a specific way so that buyers, sellers, shipping Agents and/or affiliates are able to see (or be notified) that their files were accessed or flagged and the date/time that the data was accessed or flagged.

According to a specific embodiment of the present invention, a method and/or system provides a network based integrated Marijuana Accounting Solution (MAS) which has the capability of linking in real-time and is coupled via the Internet to the database, e-commerce marketplace and the MCRM. According to a specific embodiment of the present invention, using a network, a supplier and/or seller is able to synch the MAS to their own existing 3^{rd} party accounting software (such as Quickbooks, H&R Block, and the like) and/or utilize the full MAS functionality. According to a specific embodiment of the present invention, when the supplier and/or seller manages an individual account via the internet, which may include synching the MAS to a 3^{rd} party accounting solution, then all MCRM and e-commerce data will be sent and received in real time over a network from the 3^{rd} party solution via an encrypted handshake. According to a specific embodiment of the present invention if a supplier and/or seller opts to use the complete MAS system, then the supplier and/or seller will be able to handle all their accounting and bookkeeping functions via the network. According to a specific embodiment of the present invention the complete MAS provides invoicing; selection and management of shipping agents for specific product sales; sales orders; reporting on accounts receivable; reporting on total sales in designated time periods; creation and management of supplier and seller accounts; creation and management of customer accounts; invoicing tied to e-commerce payment gateways and merchant accounts for integrated transactions; bank reconciliation interfaces and control and accounts payable reports. According to a specific embodiment of the present invention the complete MAS enables a supplier and/or seller to create sub accounts with specific areas of access, so that specific accounts can be accessed via a network, which can manage designated areas of the supplier's and/or seller's business. According to a specific embodiment of the present invention MAS and complete MAS enable a supplier and/or seller to have a truly integrated network based technology solution which helps the supplier and/or seller manage and run his or her entire organization.

According to a specific embodiment of the present invention, a method and/or system a network based marketplace for legal marijuana suppliers and/or sellers to advertise and sell legal marijuana over a network. According to a specific embodiment of the present invention users are able to search the legal marijuana database and marketplace by price, rating, location and variety of marijuana and the method and/or system will enable users to be able to complete an e-commerce transaction using a network marketplace by transacting with one or more of the suppliers and/or sellers at the same time. According to a specific embodiment of the present invention database will notify a legal marijuana supplier via the network or IVR (interactive voice response) that an order has been placed which they need to fulfill and/or ship. According to a specific embodiment of the present invention the specific customer's information, quantity of medical marijuana purchased and location of customer will be stored in a database and sent to a legal marijuana supplier and/or seller so that the legal marijuana supplier and/or seller can ship the products purchased directly to customer. According to a specific embodiment of the present invention users are able to rate and review the legal marijuana suppliers and varieties of medical marijuana that are being offered via a network based market place.

According to a specific embodiment of the present invention, a method and/or system enable legal marijuana suppliers and/or sellers to create a profile via a network, and utilize a shopping cart e-commerce system that allows the supplier and/or seller to sell their legal marijuana products via a legal marijuana specific marketplace over a network. According to a specific embodiment of the present invention a network based interface allowing merchants to enter many different legal marijuana products, photos, product descriptions, inventory amounts, their location, business and biographical information. According to a specific embodiment of the present invention the medical marijuana supplier pays a fee to have their own network based automated and turnkey shopping cart and e-commerce technology solution that enables the merchant to sell legal marijuana directly over a network.

According to a specific embodiment of the present invention, a method and/or system has a direct payment fulfillment (DPF) module that enables the legal marijuana supplier and/or seller to create an automated handshake between their own merchant account (and/or payment gateway), Paypal, Google and/or Amazon account and the e-commerce shopping cart solution that is being provided. According to a specific embodiment of the present invention the handshake between the legal marijuana supplier's merchant account, Paypal, Google and/or Amazon account and the e-commerce shopping cart occurs by the marijuana supplier and/or seller creating or managing their internet based account. According to a specific embodiment of the present invention the marijuana supplier and/or seller enters their merchant account information and/or Paypal, Google or Amazon information through a network based interface and the network based interface captures the legal marijuana's merchant account information (or Paypal, Google or Amazon account information), via fields which are stored in a database and the database then creates an automated handshake with the legal marijuana supplier and/or seller's merchant account (or Paypal, Google and/or Amazon account) to enable the legal marijuana supplier and/or seller to sell legal marijuana products over a network and to receive payment through the marijuana supplier and/or seller's merchant account (or Paypal, Google and/or Amazon account). According to a specific embodiment of the present invention when the user completes their legal marijuana purchase, the legal marijuana supplier and/or seller is notified via a network (for example, using the Internet or a wireless device) of the details of the completed transaction.

According to a specific embodiment of the present invention, a method and/or system includes an Aggregated Payment System (APS) that uses one merchant account to collect users network based e-commerce transactions on behalf of all legal marijuana suppliers and/or sellers. According to a specific embodiment of the present invention the APS has a backend accounting system that tracks amounts due to each legal marijuana supplier and/or seller. According to a specific embodiment of the present invention when the user purchases legal marijuana products from one or more legal marijuana suppliers and/or sellers the user's payment may be collected into the APS (otherwise monies are distributed directly through the DPF proportionally to quantities sold by different marijuana suppliers and/or sellers). According to a specific embodiment of the present invention the APC will track what monies are owed to the individual legal marijuana supplier and/or seller. According to a specific embodiment of the present invention the legal marijuana supplier and/or seller is able to view, manage and get real time reporting via a network based account on how many transactions have been completed, size of transactions, exact monies owed, number of users visiting their profile at the network based market place, what products of the legal marijuana supplier were viewed (and how many times). According to a specific embodiment of the present invention the APS is capable of distributing funds electronically to individual legal marijuana suppliers' and/or sellers' bank accounts.

It should be understood, of course, that the foregoing relates to exemplary embodiments of the invention and that modifications may be made without departing from the spirit and scope of the invention as set forth in the following claims.

What is claimed:

1. A method for verifying an individual's personal information over a network, comprising:
receiving an individual's personal information transmitted over a network;
verifying the individual's personal information;
determining whether or not the individual legally qualifies to purchase marijuana; and
notifying the individual whether or not he or she legally qualifies to purchase marijuana.

2. The method of claim 1, wherein the individual's personal information comprises a medical marijuana permit.

3. The method of claim 1, wherein the individual's personal information comprises streaming voice or streaming video.

4. The method of claim 1, wherein the individual's personal information comprises biometric information.

5. The method of claim 1, wherein the network comprises an intranet or the Internet.

6. The method of claim 1, wherein the network comprises a wireless network.

7. The method of claim 1, wherein the determining whether or not the person qualifies for a medical marijuana permit is automated.

8. The method of claim 1, further comprising advertising information pertaining to marijuana.

9. The method of claim 1, further comprising determining the individual's location using IP sniffing or geo tracking.

10. The method of claim 1, further comprising issuing a medical marijuana permit.

11. A method of selectively providing information pertaining to marijuana over a network, comprising:
determining an individual's geographic location;
determining whether the individual's geographic location is in a geographic area that has a government prohibiting the advertising, selling, purchasing or possessing of marijuana;
transmitting over a network to the individual information pertaining to marijuana if the individual's geographic location is in a geographic area that does not have a government prohibiting the advertising, selling, purchasing or possessing of marijuana.

12. The method of claim 11, further comprising encrypting the information pertaining to marijuana.

13. The method of claim 11, wherein the information pertaining to marijuana comprises information pertaining to a medical marijuana permit.

14. The method of claim 11, wherein determining the individual's geographic location comprises IP sniffing or geo tracking.

15. The method of claim 11, wherein the displaying the information pertaining to marijuana comprises displaying the information pertaining to marijuana on a social networking website.

16. A system for communicating information pertaining to marijuana over a network, comprising:
means for storing information pertaining to marijuana;
means for determining whether an individual is in a geographic area that has government regulations against the possession of marijuana; and
means for retrieving information from means for storing information pertaining to marijuana and transmitting information pertaining to marijuana over a network to an individual who is not in is in a geographic area that has government regulations against the possession of legal marijuana.

17. The system of claim 15, wherein the means for storing information pertaining to marijuana comprises a government maintained database.

18. The system of claim 15, wherein the information pertaining to marijuana comprises information pertaining to a government approved marijuana permit.

19. The system of claim 15, further comprises means for advertising a government approved marijuana permit.

20. The system of claim 15, wherein the means for displaying information pertaining to marijuana comprises an e-commerce website.
